(19) United States
(12) Patent Application Publication
(10) Pub. No.: US 2005/0132865 A1
(43) Pub. Date: Jun. 23, 2005

(54) Cutting system with enhanced cutting blade depth control

(76) Inventors: Wilbur S. Wridge JR., Kirkland, WA (US); Walter Daniel Krein, Lake Stevens, WA (US); Timothy Michael Dowden, Stanwood, WA (US)

Correspondence Address: Jeffrey P. Calfa, 954 Rice Court, Naperville, IL, 60565, US

(21) Appl. No.: 10/742,061

(22) Filed: Dec. 20, 2003

(51) Int. Cl. B26D 1/45

(52) U.S. Cl. 83/881; 83/940

(57) ABSTRACT

The cutting system includes an X-Y axis carrier system for transporting the blade control mechanism. The support frame holds the item to be cut, which may be a mat board. The blade control mechanism includes a hollow shaft blade cutting direction motor with a hollow shaft. The hollow shaft motor has a hollow shaft that has at least one end that protrudes from the motor. The protruded portion of the hollow shaft of the blade control mechanism is engaged to a blade holder for rotating the blade holder. As the blade control mechanism is transported, the hollow shaft motor rotates the blade using the hollow shaft and the blade holder. A plunge rod is engaged at one end to a depth control operator. The plunge rod passes through the hollow shaft of the hollow shaft motor to contact a blade carrier portion of the blade holder.

### BACKGROUND

This invention relates to a cutting system with enhanced cutting blade depth control. The invention has importance in the custom framing mat industry or other industries where flat sheets of material require cutting. Custom framing mats with various shaped and sized openings are highly desirable to customers having uniquely sized photographs or paintings. Additionally, mat purchasers desire mats with decorative cuts. These mats by their very custom nature cannot be off the shelf mass-produced items. Local hobby and craft stores require cutting systems that may provide mats with varying cutouts or openings as well as decorative cuts carved into the mats. Systems having cutting blade depth control provide increased flexibility and customer satisfaction. The cutting system of this invention may be used for mat cutting as well as other material cutting applications where fine control of blade depth is important. Too little cutting depth will not allow a complete cut through a mat or other material while too much cutting depth may cause ragged or rough surfaces on at least one face of the cut material. Too much cutting depth may inhibit a cutting system from making decorative grooved cuts that may not be cuts all the way through the material.

### SUMMARY

The cutting system includes a two dimensional X-Y axis carrier system for transporting the blade control mechanism around a cutting board or support frame. The support frame holds the item to be cut, which may be a paper, cardboard, or synthetic material. The blade control mechanism includes a hollow shaft blade cutting direction motor. The hollow shaft motor has a hollow shaft that has at least one end protruding from the motor. This protruded portion of the hollow shaft is directed towards a mat holding area of the support frame when the blade control mechanism is installed in the X-Y carrier. The protruded portion of the hollow shaft of the blade control mechanism is engaged to a blade holder for rotating the blade holder. The blade holder may be engaged to a blade. As the blade control mechanism is carried around the X-Y axis of the cutting board or support frame, the hollow shaft motor rotates the blade using the hollow shaft and the blade holder through 360 degrees of movement. The blade cuts tangent to the curve it is cutting or cutting a straight line.

A depth control or plunge rod is engaged at one end to a depth control operator. The plunge rod passes through the hollow shaft of the hollow shaft motor to contact a blade carrier portion of the blade holder. When the depth control operator drives the plunge rod into and through the hollow shaft, the plunge rod in turn increases effective blade extension from the blade cutter by pushing and sliding the blade outwards along the blade carrier portion of the blade holder. The depth control operator may be a pneumatic or hydraulic cylinder that allows for movements of the blade for different blade cutting depth or cutting height adjustments. In the alternative, the depth control operator may be a linear motor that may allow for infinite blade cutting depth variations within the blade movement range. The depth control operator, whether pneumatic, hydraulic, or electric motor driven may be driven manually as well as from a computer programmed for a design or cut.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a top down view of a carrier system for transporting the blade control mechanism around a cutting board or support frame;

FIG. 2 is a first embodiment of a blade control mechanism using pneumatics for controlling blade depth for use with the carrier system of FIG. 1;

FIG. 3 is a second embodiment of a blade control mechanism using an electric motor for controlling blade depth for use with the carrier system of FIG. 1;

FIG. 4 is a third embodiment of the a blade control mechanism using pneumatics for controlling blade depth for use with the carrier system of FIG. 1; and

FIG. 5 is a side view of a blade holder for the blade control mechanisms of FIGS. 2, 3, and 4.

FIG. 6 is a different cutaway side view of the blade holder of FIG. 5.

FIG. 7 is a rear quarter perspective of the blade holder of FIG. 5.

FIG. 8 is the rotating cam for the blade holder of FIG. 5.

FIG. 9 is an upper perspective of the blade carrier of FIG. 5.

FIG. 10 is a lower perspective of the rotating cam and blade carrier for the blade holder of FIG. 5.

FIG. 11 is a simplified version of the blade holder of FIG. 5.

### DETAILED DESCRIPTION

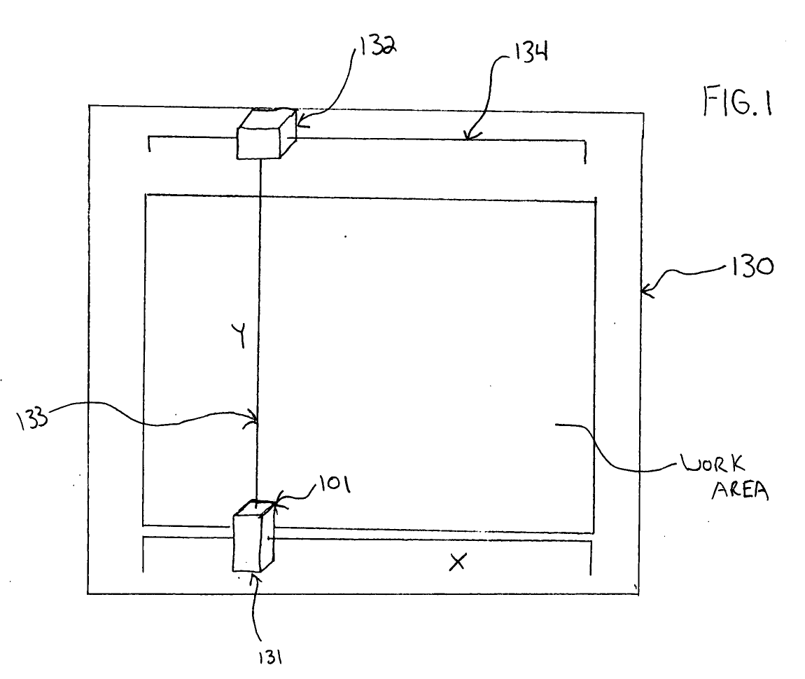

A cutting system as shown in FIG. 1 includes a two dimensional X-Y axis carrier system for transporting the blade control mechanism 101, 201, or 301 around a cutting board or support frame 130. The support frame 130 may hold an item or sheet of material to be cut, which may be a paper, cardboard, or synthetic piece of material such as mat board. Various forms of X-Y carrier systems may be applicable. The X-Y carrier system shown in FIG. 1 may include an X motive carrier driver 132 that may drive along an X pathway or drive rod 134. Additionally the X-Y carrier may have a Y motive carrier 131 that may drive along a Y pathway or drive rod 133. It should be emphasized that this X-Y carrier is only one example and that other embodiments may include other methods to drive a cutting blade control mechanism about a support frame and still be covered by this invention. For instance, the Y motive carrier and the X motive carrier could easily be the same driving unit and rails may not be necessary nor do rails when used have to be engaged to the support frame 130.

The blade control mechanism 101, 201, or 301 includes a hollow shaft blade cutting direction motor 102 with a hollow shaft 103. The hollow shaft 103 has at least one protruded end portion 104 protruding from the hollow shaft motor 102. This protruded end portion 104 of the hollow shaft 103 is directed towards a mat holding area of the support frame when the blade control mechanism 101 or 201 is installed in the X-Y carrier 130.

The protruded portion 104 of the hollow shaft 103 of the blade control mechanism 101 or 201 is engaged to a blade holder 105 for rotating the blade holder 105 and hence determining the cutting direction of a blade 108. The blade holder 105 may be engaged to a blade 108. The blade 108 may be a razor type knife or other blade capable of piercing and cutting the work material. In the preferred embodiment, the blade 108 is at a 45-degree angle from the cutting surface when the material to be cut is a mat board, although this angle may vary depending on the material to be cut and varying thickness.

As the blade control mechanism 101, 201, or 301 is carried around the X-Y axis of the cutting board or support frame 130, the hollow shaft motor 102 rotates the blade 108 using the hollow shaft 103 and the blade holder 105 through 360 degrees. Where the hollow shaft motor 102 is a stepper motor known in the art of electronics, it has the capability of rotating the blade 108 through these 360 degrees in over 3000 discrete movements. This allows flexibility in cut designs due to the increased variability of these blade steering movements. The blade cuts tangent to the curve it is cutting or cutting a straight line.

A depth control or plunge rod 106 is engaged at one end to a depth control operator 119 or 219 or 319. The depth control operator 119 may be connected to the hollow shaft motor 102 although this is not a necessity. The plunge rod 106 passes through the hollow shaft 103 of the hollow shaft motor 102 to contact a blade carrier portion 109 of the blade holder 105. When the depth control operator 119 or 219 drives the plunge rod 106 into and through the hollow shaft 103, the plunge rod 106 in turn increases effective blade extension from the blade cutter by sliding the blade 108 outwards along the blade carrier portion 109 of the blade holder 105. The blade carrier portion 109 may be slide channel formed to allow movement of the blade 108 through it. When the depth control operator 119 withdraws the plunge rod 106 through the hollow shaft 103, a spring or other potential energy storing mechanism will force the blade 108 back up the blade carrier portion 109 of the blade holder 105. Thus the depth of the blade extension is reduced and the blade 108 is withdrawn fully or partially into the blade holder 105. The spring may uniquely be a compression spring.

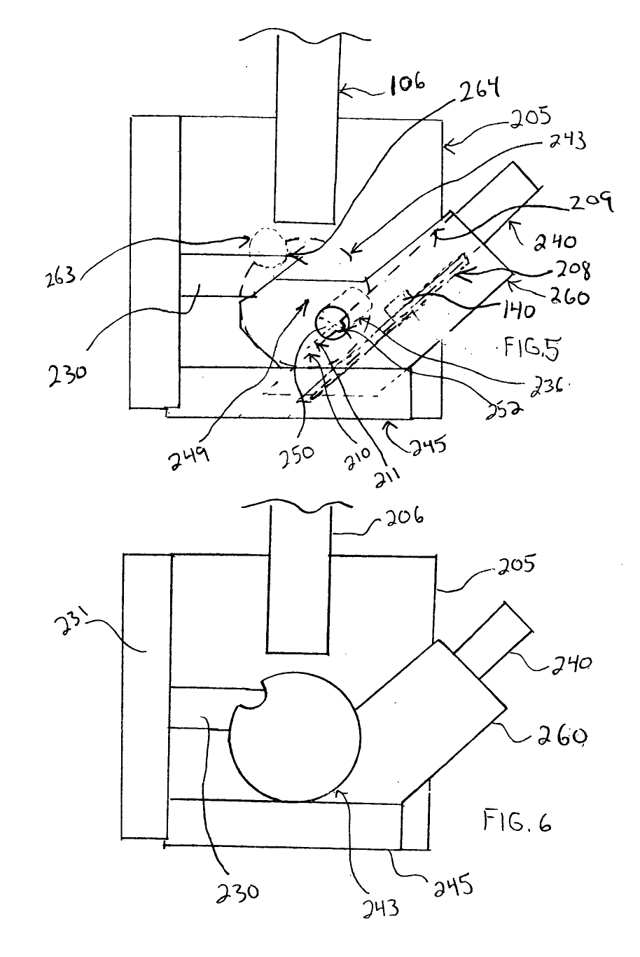

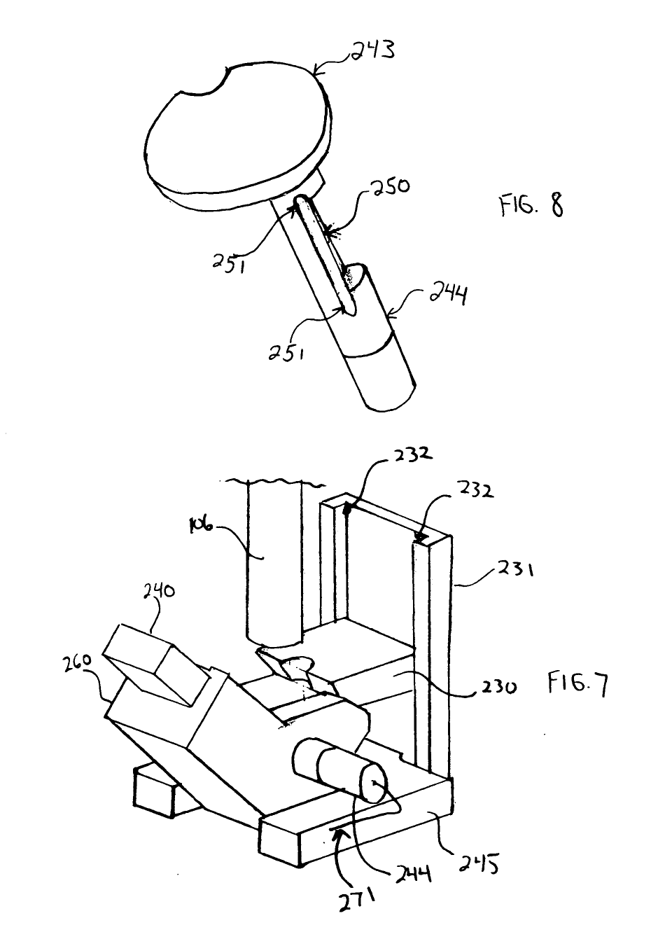

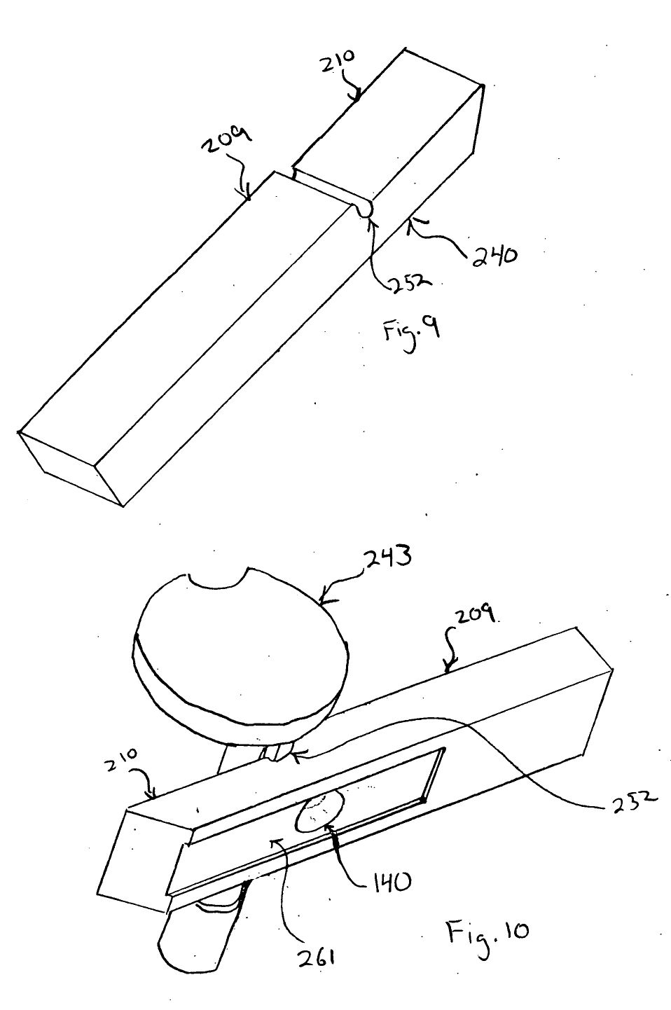

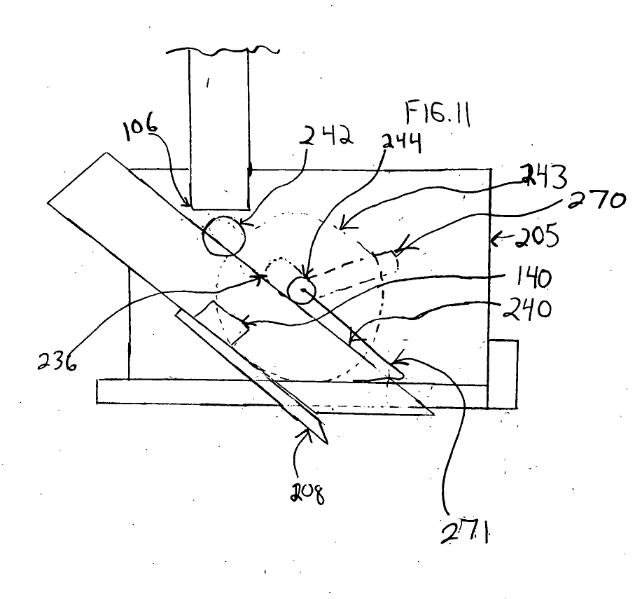

In one embodiment, the blade holder 105 may be similar to the unique design shown as blade holder as shown in FIGS. 5 to 11. In this embodiment the blade (108) is not locked in firmly until the final rotation of a rotating cam. The rotating cam incorporates a pin 250 located in slots (251). Cam (243) is used to lock shaft in open position. There is a blade cartridge 240 upon which a blade is installed. There is a foot 245 through which the blade is inserted outward. The cam 243 has rotating shaft 244. The rotating shaft 244 passes through the outer walls of the housing as well as through the blade carrier (260). There is a slot 236 in the outer walls of the (housing) 205 allowing insertion movement of the rotating shaft 244 as well as the carrier (260). The blade cartridge 240 as shown in FIG. 10 has a magnet 140 on one face for engaging the blade 208. The blade cartridge 240 contains a blade slot 261 for engagement of the blade 208. The blade cartridge 240 has a locking notch 252. This locking notch 252 is important for accomplishing the final rotation locking of the pin 250 in slot 251. The blade cartridge 240 has a magnet for initial holding of the blade. This cartridge 208 is inserted into the blade cartridge carrier (260) until the locking notch 252 aligns with the locking pin (250) located on the shaft 244 at which time the shaft rotates and the locking pin (250) falls into the slot and is forced there with the pressure of a torsion spring 271 and wedging the blade and blade cartridge into place. The torsion spring applies a rotational force upon the shaft 244. For this embodiment, the plunge rod 106 is similar to the plunge rod 106 above. The depth control operator drives the plunge rod 106 downward passing side support 230. The plunge rod 106 initially contacts the blade cartridge carrier 260, moving the unit with the blade 208, the blade cartridge (240), and the blade cartridge carrier (260) downward along the slot 236 formed within the housing 205 and placing the blade into a cutting position.

The following explanation should help clarify the operation of the blade holder 105 structure described above. The plunge rod 106 only moves in an upward and downward direction. The plunge rod 106 only pushes on a horizontal angle slide pin 242. The blade cartridge carrier (260) slides at a 45 degree angle down and forward as the plunge rod 106 pushes on the pin 242. The pin 242 slides across the bottom of the plunge rod 106 as the plunge rod is moving downward allowing the carrier (260) attached to it to move downward at a 45 degree angle carrying the blade cartridge (204) and blade (208) with it into cutting position. The mechanism 101 or 102 is imparting only a downward force with the plunge rod 106 but since the rod 106 is pushing on pin (242) mounted on the carrier (260) it is converting a vertical downward force to a 45-degree downward force. The blade 208 is mounted on the blade cartridge 240, which is removed from the carrier 260 for replacing the blade 208. The blade cartridge (240) is inserted into a sliding cartridge carrier (260), which moves downward and forward by force from the plunge rod carrying the blade cartridge 240 and blade 208 with it. The following items are meant to securely hold the blade cartridge 240 in place during cutting. A handle 270 on the end of the shaft (244) is rotated until a semicircular notch (264) in the cam shaped disc 243 aligns with a pin 263 protruding from the side of the housing (205) and the notch 264 falls over the pin 263 therefore locking the unit open so the blade cartridge 240 can be removed. After a new blade is placed in the blade cartridge (240) (being held in place temporarily with a magnet 140) the blade cartridge (240) is inserted into a matching slot in the blade cartridge carrier (260). There is a small locking pin 250 mounted horizontally on the rotating main shaft 244 that will eventually line up with a slot 252 on the back of the blade cartridge (240). As the blade cartridge (240) is manually pushed forward into the blade cartridge carrier (260) the force exerted will push the blade cartridge carrier (260) forward and cause the semi circle notch 264 in the cam 243 to be lifted off the pin 263 that was holding it in place and a torsion spring 271 mounted on the side of the housing (205) and connected to the main shaft will cause the main shaft 244 to rotate and the locking pin (250) will fall into the slot 252 on the back of the blade cartridge 240. Due to the large force of the tension spring 271 and the close proximity of the locking pin 250 so close to the center of rotation of the main shaft 244 it creates a very large lever advantage at the locking pin 250 therefore holding the blade cartridge (240) firmly in place. Since the blade 208 thickness is slightly thicker than the blade indented area or blade receiving slot 261 on the blade cartridge 240 the blade 208 is firmly pushed against the blade cartridge 240 and therefore locking the blade 208 in place while plunging and un-plunging into and out of the mat board.

The Blade Cartridge (240) with magnet 140 carries and holds the blade (208) in precise cutting position. As the cartridge (240) is inserted into the carrier (260) the thin end (210) end slides under the shaft (244) until it stops against the shaft (244) at the ledge created at the notch (252). When slightly more force is exerted by the operator, it causes the carrier (260) to move forward along with the shaft (244). This continued forceful movement causes the semicircle (264) in the cam (243) to disengage from the pin (263), allowing the shaft 244 to rotate powered by the torsion spring 271, therefore causing the locking pin (250), that is part of the shaft (244), to engage slot (252) in the cartridge. The Blade cartridge Carrier (260) carries the blade (108) and blade cartridge (240) at a 45-degree [or other angle] angle relative to the mat board. The shaft 244 engages a loose hole in the carrier (260) to allow rotation for locking. The shaft 224 then rotates to allow clamping of blade cartridge (240) and blade (208). The shaft 244 has cam (243) on end to allow locking in the open position for changing blades and the shaft contains a small horizontal offset locking pin (250), which snaps into slot (251). This pin 250 acts like a cam that engages into the slot (252) in the blade cartridge (260) thereby clamping the blade cartridge and blade in place when the shaft (244) is rotated. A finger handle 270 is attached to the end of the shaft (244) for rotating shaft into an open position-engaging semicircle (264) with pin (263) to allow removal of the blade cartridge and blade. See FIG. 11. A torsion spring 271 is held in place between this handle and the housing (not pictured) to provide energy for the blade locking. There is a head block (not pictured) connected to the motor shaft (104) and provides support and alignment for all other members. The head block actually does nothing except attach the entire assembly to the motor shaft. It is the housing (205), which surrounds the head block that contains the slot (252), locking pin (263) and a lower polished surface for the blade cartridge carrier (260) to slide on. The Housing (205) surrounds the head block and holds and aligns the Block (not shown) and other parts and contains a slot 236 on the side of the housing (not pictured) that allows the shaft (244) to slide forward at 45 degrees and a pin (263) to allow the cam (243) to engage for holding shaft (244) in open position for blade changes. The Locking Pin (250) fits in notches (251) and rotationally engages in slot (252) of the blade cartridge (240) for locking blade cartridge and blade into position.

The rotating shaft 244 of the cam 243 has a semi-circular region and locking pin are 250 in the middle area. The semi-circular region or edge carrying region may have notches 251 with a pin 250 that acts as a cam at the interface with the circular end regions of the rotating shaft 244. The blade cartridge 208 has a magnet for initial holding of the blade. This cartridge 208 is inserted into the blade cartridge 240 until the locking notch aligns with the rotating shaft of the cam 243. At which time a torsion spring 271 rotates the cam 243 locking the blade cartridge 208 and wedging the blade into place. For this embodiment, the plunge rod 106 is similar to the plunge rod 106 above. The depth control operator drives the plunge rod 106 downward passing side support 230 that is engaged to slots 232 in the back wall 231. The plunge rod 106 initially contacts the blade cartridge 240, moving the unit with the blade 208, the blade cartridge, and the blade cartridge 240 downward along the slot 236 in the outer walls of the blade holder 205 and placing the blade into a cutting position.

The following explanation should help clarify the operation of the blade holder 205 structure described above. The plunge rod 106 only moves in an upward and downward direction. The plunge rod 106 only pushes on a horizontal angle slide pin 242 mounted on the blade cartridge carrier 240. The blade cartridge carrier 240 slides at a 45 degree angle forward as the plunge rod 106 pushes on it and the pin 242 slides along the bottom end of the plunge rod 106 as it moves the pin 242 forward and down at 45 degrees. The mechanism 101 or 102 is imparting only a downward force with the plunge rod 106 but since the rod 106 is mounted on the sliding carrier 240 it is converting a vertical downward force to a 45-degree downward force. The blade 208 is mounted on the blade cartridge 240, which is removed from the foot block 260 for replacing the blade 208. The blade cartridge 208 is inserted into a sliding cartridge carrier 240, which moves downward and forward by force from the plunge rod carrying the blade cartridge 240 and blade 208 with it. The following items are meant to securely hold the blade cartridge 240 in place during cutting. A handle 270 on the side of the foot block 260 is rotated until a semicircular notch 264 in the cam shaped disc 243 aligns with a pin 263 protruding from the side of the foot block 260 and the notch 264 falls over the pin 263 therefore locking the unit open so the blade cartridge 240 can be removed. After a new blade is placed in the blade cartridge 208 (being held in place temporarily with a magnet 140) the blade cartridge 208 is inserted into a matching slot in the blade cartridge carrier 240. There is a small locking pin 250 mounted horizontally on the rotating main shaft 244 that will eventually line up with a slot on the back of the blade cartridge 208. As the blade cartridge 208 is manually pushed forward into the blade cartridge carrier 240 the force exerted will push the blade cartridge carrier 208 forward and cause the semi circle notch 264 in the cam 243 to be pushed off the pin 263 that was holding it in place and a torsion spring 271 mounted on the side of the foot block and connected to the main shaft 244 will cause the main shaft to rotate and the locking pin 250 will fall into the slot 252 on the back of the blade cartridge 240. Due to the large force of the torsion spring 271 and the close proximity of the locking pin 250 so close to the center of rotation of the main shaft 244 it creates a very large lever advantage at the locking pin 250 therefore holding the blade cartridge 208 firmly in place. Since the blade 208 thickness is slightly thicker than the blade indented area or blade receiving slot 261 on the blade holder 240 the blade 208 is firmly pushed against the blade cartridge carrier 240 and therefore hopefully locking the blade 208 in place while plunging and un-plunging into and out of the mat board.

The depth control operator may be a pneumatic cylinder system 119 that allows for discrete or finite movements or of the blade 108 for different blade cutting depth or cutting height adjustments. This is shown in the embodiment shown in FIG. 2. A cylinder shaft 107 is engaged at one end to the end of the plunge rod 106 opposite to that attached to the used to push to extend the blade 108. The cylinder shaft 107 is engaged at its other end to the internal piston 121 of the pneumatic cylinder. The piston 121 moves within an operating chamber 120 of the pneumatic cylinder 119. An air supply A is applied through an air operator 122 to an upper side of the piston 121 to apply blade extension force through the cylinder shaft 107, and the plunge rod 106 through the hollow shaft 103 to the blade 108 along the blade carrier 109. The pneumatic cylinder 119 could easily be replaced with a hydraulic cylinder that would apply blade extension force through the application of hydraulic fluid from a source A to a piston 121. Potential energy is stored in a spring upon application of air A to the upper side of the piston 121 and when air is vented from the upper side of the piston 121, the spring forces the piston 121 in a direction to retract the blade 108 or reduce blade 108 extension.

The depth of blade 108 plunge may be adjusted manually through a pneumatic cylinder knob or adjuster 124 that rotates an end stop shaft 123 to raise or lower an end stop 125. The end stop 125 has an upper stop surface. The lower portion of the piston 121 comes to rest against the upper stop surface of the end stop 125 at the predetermined blade extension stop. The predetermined blade extension stop may be set by the pneumatic cylinder knob 124 adjustment of the height of the end stop 125. The adjustable end stop 125 makes the pneumatic cylinder 119 have a variable effective size due to the varied piston 121 movement.

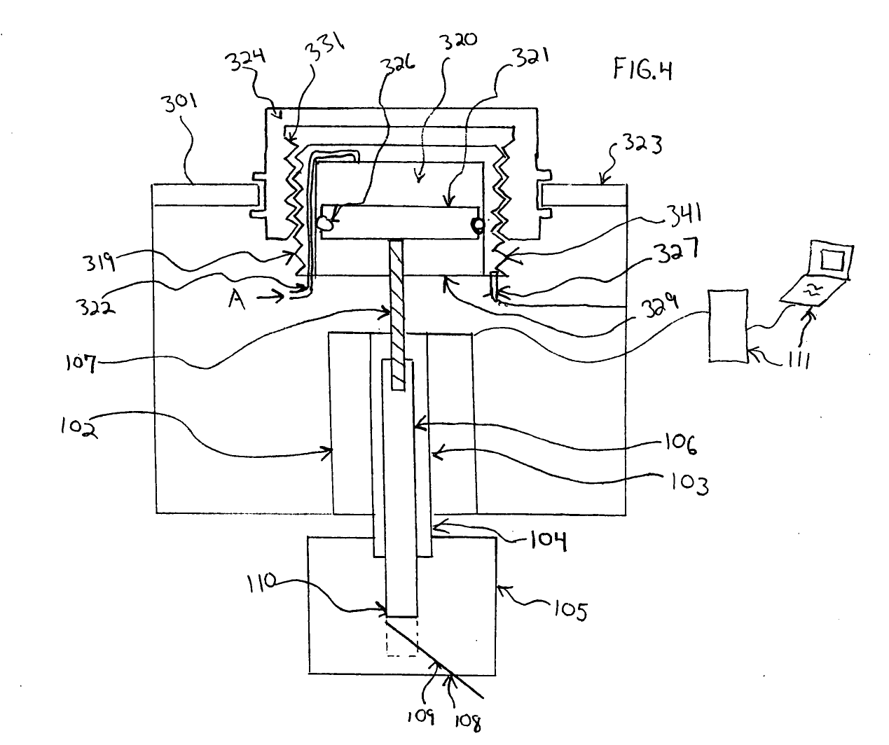

In the embodiment shown in FIG. 4, there is a different blade plunge limiter. In this preferred embodiment, depth of blade 108 plunge may be adjusted manually through a second pneumatic cylinder knob or adjuster 324 that rotates about a head top plate 323 of the blade control mechanism 301. The second pneumatic cylinder knob 324 is stationary in the vertical direction. There are internal threads 331 on the inner chamber walls of the second pneumatic cylinder knob 324 on which a movable cylinder 319 rides upwards or downwards depending on the rotation of the second pneumatic cylinder knob 324; the movable cylinder 319 having external threads 341 to match the internal threads 331 of the second pneumatic cylinder knob 324. The movable cylinder 324 not rotating due to an anti-rotation pin 321 that is fixed in the radial direction to an internal portion of the blade control mechanism 301. The movable cylinder 324 has internal piston 321 that rides up or down on the inner walls of the movable cylinder 319 about sealing rings 326. The internal piston 321 is engaged to the cylinder shaft 107 to operate the blade 108 of the blade holder in a similar fashion as described above in the blade control mechanism 101. The movable cylinder 319 has an air supply A and an internal air line 322 that leads to the operating area 320 of the movable cylinder. The movable cylinder 319 has a lower piston stop area 329 against which the internal piston 321 stops at upon being downward driven. Rotation of the second pneumatic cylinder knob 324 raises or lowers the movable piston 321 that in turn varies the piston stop area 329 and hence varies the plunge depth of the amount of plunge rod 106 movement and hence blade 108 movement. The predetermined blade extension stopping point being set by the pneumatic cylinder knob 324 adjustment of the height of the piston stop area 329.

In one commercialized embodiment, the cylinder knob or adjuster is located on top of the cylinder 119 head and is calibrated in 24 segments. Each segment represents a 0.006-inch plunge of the blade 108 through a material to be cut. If the material is mat board, its thickness may vary from 0.050″ to 0.200″ and the desired blade protrusion through the backside of the mat would be 0.010″ to fully cut out the opening. In situations where decorative cuts are made in the face of the mat without cutting all the way through, the blade is set for a depth that is less than the overall mat thickness. The cutting mechanism 101 or 201 is then directed for return pass in the other direction. An angled blade 108 allows for such Vee channels to be cut into the face of the mat material. The pneumatic cylinder knob 124 in this one embodiment is designed to rotate the end stop 125 through the end stop shaft 123 to the desired location to achieve the desired blade 108 depth. The cutting system described here is in no way limited to the above specifications. This commercialized embodiment is only described as way of example of a preferred but not the only workable embodiment of a cutting system.

The depth of the blade 108 plunge may also be adjusted automatically through an external driver unit such as pneumatics, hydraulics, electromagnets, or motor which would take the place of the pneumatic cylinder knob 124.

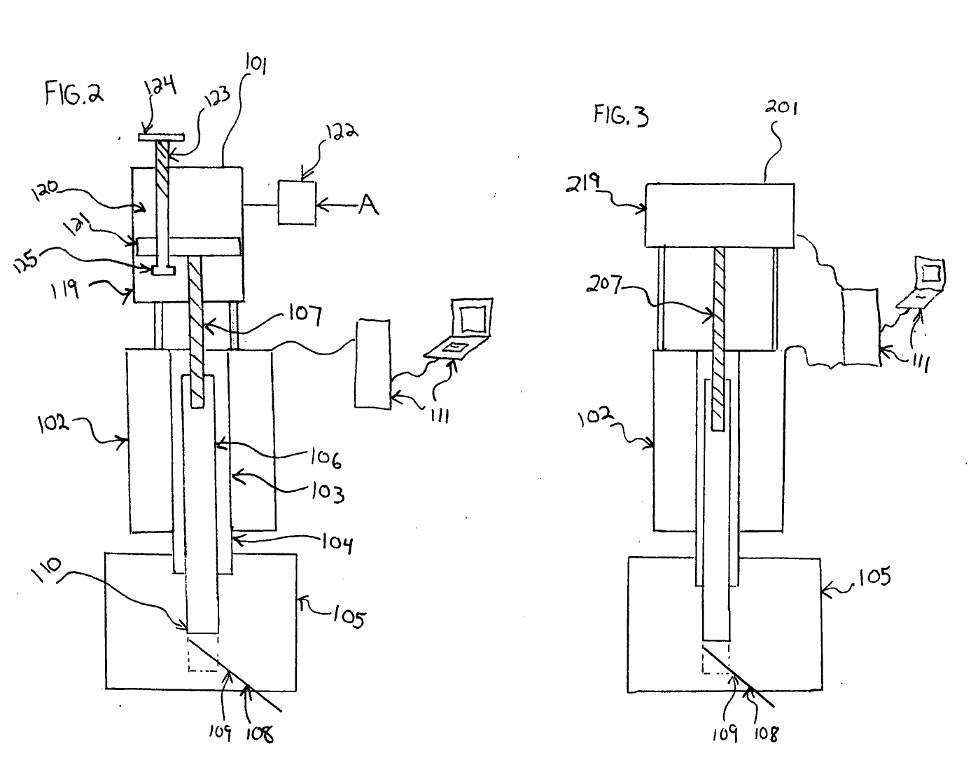

In an alternative embodiment, the depth control operator may be a linear motor 219 that may allow for infinite blade cutting depth variations within the blade movement range. This is shown in the embodiment in FIG. 3. The linear motor 219 in this embodiment is engaged to a motor shaft 207 that takes the place of the cylinder shaft 107 described in the above embodiment. This arrangement creates some advantages. Since the depth of the blade 108 is controlled by a linear motor such as a small stepper motor that may be controlled by a computer 111, the users of the cutting system may be able to precisely control the depth of the blade while the blade 108 is cutting the material. The user may therefore better control the designs she produces in the mat board surface. Sometimes the user may direct the cutting system to cut all the way through and sometimes it will be cutting variable depth Vee grooves. The linear motor 219 allows the computer 111 to be pre-programmed for various thickness of mat board from different manufacturers of mat board. The linear motor 219 may be either a servo or stepper motor.

The depth control operator electric motor 219 driven may be driven manually as well as from a computer 111 programmed for a design or cut. The hollow shaft motor may also be driven by a computer or chip 111 programmed to coordinate the three dimensions of cuts in materials; the hollow shaft motor 102 controlling the X and Y direction, the X-Y carrier system X-Y location and the depth control operator controlling the Z or height axis.

As described above, the embodiments of the cutting system provide a number of advantages, some of which have been described above and others of which are inherent in the invention. Also modifications may be proposed to the embodiments of the cutting system without departing from the teachings herein.

1. A cutting system for cutting flat sheets of material, comprising:
a two dimensional X-Y axis carrier system for transporting a blade control mechanism around a support frame;
said support frame for holding a sheet of material to be cut;
said blade control mechanism having a blade cutting direction hollow shaft motor with a hollow shaft;
said hollow shaft having at least one protruded end portion protruding from said hollow shaft motor;
said protruded end portion of said hollow shaft being directed towards a material holding area of said support frame when said blade control mechanism is installed in to move in said X-Y carrier;
said protruded end portion of said hollow shaft of said blade control mechanism being engaged to a blade holder for rotating said blade holder to determine cutting direction;
said blade holder for holding a blade:
a plunge rod being engaged at one end to a depth control operator;
said plunge rod passing through said hollow shaft of said hollow shaft motor to contact a blade carrier portion of said blade holder; and
said depth control operator engaged to drive said plunge rod into and through said hollow shaft to cause said plunge rod to increase effective blade extension by sliding a blade outwards along with a blade carrier portion of said blade holder.

2. The cutting system of claim 1, wherein;
said depth control operator is a pneumatic cylinder.

3. The cutting system of claim 2, wherein:
a cylinder shaft is engaged at one end to an end of said plunge rod opposite to that attached to push to extend a blade in said blade holder;
said cylinder shaft is engaged at a second end to an internal piston of said pneumatic cylinder;
said internal piston moveable within an operating chamber of said pneumatic cylinder; and
an air supply through an air operator to an upper side of said piston to apply blade extension force through said cylinder shaft, and said plunge rod through said hollow shaft to a blade along said blade carrier.

4. The cutting system of claim 3, wherein:
depth of blade plunge being adjustable through a pneumatic cylinder adjuster that rotates an end stop shaft to reposition an end stop located on said end stop shaft; and
a lower portion of said internal piston having a travel limit against said end stop at a predetermined blade extension stop.

5. The cutting system of claim 4, wherein:
said pneumatic cylinder is engaged to said hollow shaft motor.

6. The cutting system of claim 5, wherein:
said hollow shaft motor is a stepper motor controlled by a computer processor.

7. The cutting system of claim 1, wherein;
said depth control operator is a hydraulic cylinder.

8. The cutting system of claim 7, wherein:
a cylinder shaft is engaged at one end to an end of said plunge rod opposite to that attached to the used to push to extend a blade in said blade holder;
said cylinder shaft is engaged at a second end to an internal piston of said hydraulic cylinder;
said internal piston moveable within an operating chamber of said hydraulic cylinder; and
a hydraulic fluid supply through an operator to an upper side of said piston to apply blade extension force through said cylinder shaft, and said plunge rod through said hollow shaft to a blade along said blade carrier.

9. The cutting system of claim 8, wherein:
depth of blade plunge being adjustable through a hydraulic cylinder adjuster that rotates an end stop shaft to reposition an end stop located on said end stop shaft; and
a lower portion of said internal piston having a travel limit against said end stop at a predetermined blade extension stop.

10. The cutting system of claim 9, wherein:
said hydraulic cylinder is engaged to said hollow shaft motor.

11. The cutting system of claim 10, wherein:
said hollow shaft motor is a stepper motor controlled by a computer processor.

12. The cutting system of claim 1, wherein:
said depth control operator is a linear motor.

13. The cutting system of claim 12, wherein:
said linear motor being engaged to a motor shaft;
said motor shaft being engaged to an end of said plunge rod opposite to that attached to push to extend a blade in said blade holder; and
said linear motor for adjusting blade extension and blade depth through said motor shaft, said plunge rod, and said blade holder.

14. The cutting system of claim 13, wherein:
said linear motor controlled by a computer processor programmed to control blade depth prior to, during, or after blade control mechanism movement.

15. The cutting system of claim 14, wherein:
said linear motor is engaged to said hollow shaft motor.

16. The cutting system of claim 15, wherein:
said hollow shaft motor is a stepper motor controlled by said computer processor.

17. A blade control mechanism for a cutting system, comprising:
a blade cutting direction hollow shaft motor with a hollow shaft;
said hollow shaft having at least one protruded end portion protruding from said hollow shaft motor;
said protruded end portion of said hollow shaft of said blade control mechanism being engaged to a blade holder for rotating said blade holder to determine cutting direction;
said blade holder for holding a blade;
a plunge rod being engaged at one end to a depth control operator;
said plunge rod passing through said hollow shaft of said hollow shaft motor to contact a blade carrier portion of said blade holder;
said depth control operator engaged to drive said plunge rod into and through said hollow shaft to cause said plunge rod to increase effective blade extension by moving a blade outwards along with a blade carrier portion of said blade holder;
said depth control operator is a pneumatic cylinder;
depth of blade plunge being adjustable through a pneumatic cylinder adjuster that repositions an end stop within said pneumatic cylinder; and
an internal piston of said pneumatic cylinder having a travel limit defined by said end stop at a predetermined blade extension stop.

18. The cutting system of claim 17, wherein:
said pneumatic cylinder is engaged to said hollow shaft motor.

19. The cuffing system of claim 18, wherein:
said hollow shaft motor is a stepper motor controlled by a computer processor.

20. A blade control mechanism for a cutting system, comprising:
a blade cutting direction hollow shaft motor with a hollow shaft;
said hollow shaft having at least one protruded end portion protruding from said hollow shaft motor;
said protruded end portion of said hollow shaft of said blade control mechanism being engaged to a blade holder for rotating said blade holder to determine cutting direction;
said blade holder for holding a blade;
a plunge rod being engaged at one end to a depth control operator;
said plunge rod passing through said hollow shaft of said hollow shaft motor to contact a blade carrier portion of said blade holder;
said depth control operator engaged to drive said plunge rod into and through said hollow shaft to cause said plunge rod to increase effective blade extension by moving a blade outwards along with a blade carrier portion of said blade holder;
said depth control operator is a hydraulic cylinder;
depth of blade plunge being adjustable through a hydraulic cylinder adjuster that repositions an end stop within said pneumatic cylinder; and
an internal piston of said hydraulic cylinder having a travel limit defined by said end stop at a predetermined blade extension stop.

21. The cutting system of claim 20, wherein:
said hydraulic cylinder is engaged to said hollow shaft motor.

22. The cutting system of claim 21, wherein:
said hollow shaft motor is a stepper motor controlled by a computer processor.

23. A blade control mechanism for a cutting system, comprising:
a blade cutting direction hollow shaft motor with a hollow shaft;
said hollow shaft having at least one protruded end portion protruding from said hollow shaft motor;
said protruded end portion of said hollow shaft of said blade control mechanism being engaged to a blade holder for rotating said blade holder to determine cutting direction;
said blade holder for holding a blade;
a plunge rod being engaged at one end to a depth control operator;
said plunge rod passing through said hollow shaft of said hollow shaft motor to contact a blade carrier portion of said blade holder;
said depth control operator engaged to drive said plunge rod into and through said hollow shaft to cause said plunge rod to increase effective blade extension by moving a blade outwards along with a blade carrier portion of said blade holder;
said depth control operator is a linear motor;
said linear motor being engaged to a motor shaft;
said motor shaft being engaged to an end of said plunge rod opposite to that attached to said end used to push to extend a blade in said blade holder; and
said linear motor for adjusting blade extension and blade depth through said motor shaft, said plunge rod, and said blade holder.

24. The cutting system of claim 23, wherein:
said linear motor controlled by a computer processor programmed to control blade depth prior to, during, or after blade control mechanism movement.

25. The cutting system of claim 24, wherein:
said linear motor is engaged to said hollow shaft motor.

26. The cutting system of claim 25, wherein:
said hollow shaft motor is a stepper motor controlled by said computer processor.

27. The cutting system of claim 2, wherein:
a cylinder shaft is engaged at one end to an end of said plunge rod opposite to that attached to push to extend a blade in said blade holder;
said cylinder shaft is engaged at a second end to an internal piston of said pneumatic cylinder;
blade depth being adjustable through a pneumatic cylinder adjuster knob that is stationary in a vertical direction, said cylinder adjuster knob having internally threaded inner wall upon which a movable cylinder may rid upwards or downwards;
said movable cylinder having external threads matching said internally threaded inner wall of said pneumatic cylinder adjuster knob;
said movable cylinder being fixed radially such that rotation of said pneumatic cylinder adjuster knob causes upwards or downwards movement of said movable cylinder;
said movable cylinder having said internal piston that may ride up or down on inner walls of said movable cylinder;
said movable cylinder having an air supply leading to an upper portion of said piston, air providing downward pressure upon said piston;
said movable cylinder having a lower piston stop area against which said piston stops at upon being downward driven; and
rotation of said pneumatic cylinder adjuster knob raises or lowers said movable piston varying piston stop area height and varying plunge depth of said plunge rod and hence blade depth.

28. The cutting system of claim 27, wherein:
said pneumatic cylinder is engaged to said hollow shaft motor.

29. The cutting system of claim 28, wherein:
said hollow shaft motor is a stepper motor controlled by a computer processor

30-33. (canceled)
